(19) United States
(12) Patent Application Publication
(10) Pub. No.: US 2022/0330718 A1
(43) Pub. Date: Oct. 20, 2022

(54) BOX PLINTH AND METHOD OF ASSEMBLY

(71) Applicant: John Boothby, Coogee, New South Wales (AU)

(72) Inventor: John Boothby, Coogee, New South Wales (AU)

(21) Appl. No.: 17/638,475

(22) PCT Filed: Aug. 25, 2020
(86) PCT No.: PCT/AU2020/050890

§ 371 Date: Feb. 25, 2022

(30) Foreign Application Priority Data
Aug. 26, 2019 (AU) 2019903113

(51) Int. Cl. A47F 3/00; F16B 12/46; F16B 12/02

(52) U.S. Cl. CPC A47F 3/004; F16B 12/46; F16B 12/02

(57) ABSTRACT

A box plinth and method of assembly which can be used in a display capacity providing the ability to change the appearance of the box plinth by removing the semi-rigid sheet members on the outside of the box plinth and replacing them with alternative semi-rigid sheet members without requiring that the entire box plinth be replaced.

### FIELD

The present invention relates generally to shop fitting or display apparatus and more particularly to a box plinth and method of assembly which can be used in a display capacity.

### BACKGROUND

In the field of shop fitting or display apparatus for use in advertising, a box plinth is commonly used as a base on which a display such as a dressed mannequin for example is placed in order to elevate the display.

Conventional box plinths are typically moulded three-dimensional shapes, generally three-dimensional rectangular shapes which are moulded out of a plastic material and which typically have a finishing colour or surface applied to an outside of the shape. The finishing colour or surface is applied permanently to the outside. The only method by which the surface finish or colour can be amended is to essentially reapply a different surface finish or colour over the top of the existing finish or colour. This is both time-consuming and expensive. Changing a surface finish or colour is quite often necessary to fit within the particular advertising campaign of the display owner and/or their corporate or desired colour schemes.

An additional issue is faced with conventional box plinths if the box plinth is accidentally damaged. The box plinth can be repaired but again, this is time-consuming and can be expensive depending on the nature of the damage. Additionally, the point boxes unavailable for the display while the repair is undertaken.

Still further, conventional box plinths are only available in the sizing which they are supplied. In other words, the size of the box plinth cannot be changed once it is moulded and if a different size box plinth is required, then a different box plinth must be sourced and supplied to site. This generally results in a retailer having a large supply of box plinths of different sizes and shapes which then must be stored somewhere when not in use. This storage increases the chance that the box plinth will be damaged.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a box plinth and method of assembly, which may at least partially overcome at least one of the abovementioned disadvantages or provide the consumer with a useful or commercial choice.

In a first aspect of the invention, there is provided a box plinth comprising:

a rigid frame structure in the form of an open frame three-dimensional polygon, the rigid frame structure comprising:
a plurality of apex connectors, and
a plurality of elongate frame members connected to and extending between respective apex connectors of the plurality of apex connectors to form the rigid frame structure;

wherein each elongate frame member comprises a channel forming lip along an outer edge thereof to form a channel along the length thereof, which together with neighbouring elongate frame members forms a perimeter channel about each planar face of the open frame polygon, the perimeter channel configured to receive and retain a planar sidewall therein.

In an embodiment, the box plinth further comprises at least one planar side wall (which may be in the form of a rigid or semi-rigid sheet member), wherein edges or edge portions of the at least one planar side wall are retained in the perimeter channel to close a planar face of the open frame polygon.

In an embodiment, the box plinth further comprises a rigid wall member removably locatable relative to the rigid frame to at least partially close the open frame shape, e.g. by being inserted within and closing a planar face of the rigid frame.

In an embodiment, the channel forming lip forms two channels along at least two sides of the elongate frame member, the at least two sides being convergent sides which converge to form the outer edge.

In a second aspect of the invention, there is provided a box plinth comprising:
a) a rigid frame including:
   i. a pair of end frame assemblies each formed from a number of alternating apex connectors and elongate frame members extending therebetween;
   ii. a number of elongate frame members extending between respective apex connectors of the respective end frame assemblies to form a three-dimensional open frame shape;
   each of the elongate frame members including a channel-forming lip to define a channel on an outermost side of each of the frame members;
b) at least one rigid wall member removably located relative to the rigid frame to at least partially close the open frame shape; and
c) at least one semi-rigid sheet member removably locatable relative to the frame at each edge by location in the respective channel, the at least one semi-rigid sheet member located substantially parallel to and outside the respective rigid sidewall member.

In forms of the invention, the box plinth can be assembled and disassembled as required and, more importantly, by changing the at least one semi-rigid sheet member which is removably located relative to the frame, the external appearance of the box plinth can be adjusted as necessary. In addition, partial disassembly may be possible. Due to the provision of the rigid frame, the rigid side wall members can be removed from the frame to reduce weight and the frame moved whilst still assembled and then the rigid side wall members repositioned with the sheet members then relocated to complete reassembly of the box plinth. However, in alternative forms, the box plinth cannot be readily disassembled.

In an embodiment of the first or second aspects, the box plinth is modular.

In an embodiment of the first or second aspects, the box plinth further comprises one or more internal shelves.

In one or more forms of the first or second aspects, or embodiments thereof, the at least one planar sidewall or semi-rigid sheet is formed from a polymer material such as a high density polyurethane board.

In one or more forms of the first or second aspects, or embodiments thereof, the at least one planar sidewall or semi-rigid sheet member is magnetic and/or comprises a magnet receptive material. By magnetic metal, it is meant those metals that are attracted to magnets. Suitable metals may be selected from the group consisting of iron, nickel, cobalt, and/or magnetic alloys containing one or more of the foregoing. The at least one planar sidewall or semi-rigid sheet may be formed from the magnetic metal; comprise a layer of the magnetic metal; or include the magnetic metal embedded, such as in the form of metal filings, within or on a matrix material (such as a paper or polymer film).

In one implementation of the above forms, the at least one planar sidewall or semi-rigid sheet comprises a base layer and a paper or polymer film layer adhered thereto, the paper or polymer film layer being magnetic or comprising the magnet receptive material. Preferably the base layer is formed from a polymer such as high density polyurethane board.

In one or more forms of the first or second aspects, or embodiments thereof, the rigid wall member forms a base or a ceiling of the box plinth.

In one implementation of the above forms, the box plinth includes a second rigid wall member removably located relative to the rigid frame to at least partially close the open frame shape, wherein the second rigid sidewall member forms the other of the base or the ceiling of the box plinth, e.g. a base to provide a support base for supporting the box plinth on a surface, and a ceiling to support items resting thereon.

In an embodiment of the first or second aspects, the box plinth is in the form of a cube or rectangular prism.

In an embodiment of the first or second aspects, each apex connector comprises a plurality of male connectors, and each elongate frame member comprises two female connectors at opposite longitudinal ends thereof, the male connectors configured to be received within the female connectors. Preferably each male connector is orthogonal to each other. Preferably, each apex connector comprises three male connectors.

In an embodiment of the first or second aspects, each apex connector is hollow and comprises one or more openings in external facing surfaces thereof.

In an embodiment of the first or second aspects, the elongate frame members comprise an elongate body with one or more support ribs extending substantially along a longitudinal length of the elongate body. Preferably, the elongate body is hollow.

In one form of the above embodiment, at least one of the support ribs provides a receiving surface for supporting or retaining the rigid sidewall member.

In an embodiment of the first or second aspects, each apex connector comprises channel forming lips along an outer edge thereof configured to align with channel forming lips of elongate frame members connected thereto.

In an embodiment of the first or second aspects, the apex connectors are formed from a polymer material and the elongate frame members are formed from a light metal or light metal alloy. A non-limiting disclosure of suitable light metals or light metal alloys comprise those selected from the group consisting of: aluminium, titanium, magnesium and alloys of one or more of the foregoing.

In a third aspect of the invention, there is provided a kit for a box plinth comprising:

a plurality of apex connectors, and

a plurality of elongate frame members configured to be connected to and extend between respective apex connectors of the plurality of apex connectors to form a rigid frame structure in the form of an open frame three-dimensional polygon,
wherein each elongate frame member comprises a channel forming lip along an outer edge thereof to form a channel along the length thereof, which together with neighbouring elongate frame members forms a perimeter channel about each planar face of the open frame polygon, the perimeter channel configured to receive and retain a planar sidewall therein.

In an embodiment, the kit further comprises at least one planar side wall (which may be in the form of a rigid or semi-rigid sheet member), wherein edges or edge portions of the at least one planar sidewall are configured to be retained in the perimeter channel to close a planar face of the open frame polygon.

In one form of the above embodiment, the at least one planar sidewall is magnetic and/or comprises a magnet receptive material; and the kit further comprises at least one magnetic skin configured to be magnetically retained on the at least one planar side wall.

In an embodiment, the kit further comprises a rigid wall member configured to be removably located relative to the rigid frame to at least partially close the open frame structure.

In an embodiment, the box plinth is in the form of a cube or rectangular prism.

In an embodiment, each apex connector comprises a plurality of male connectors, and each elongate frame member comprises two female connectors at opposite longitudinal ends thereof, the male connectors configured to be received within the female connectors. Preferably each male connector is orthogonal to each other. Preferably, each apex connector comprises three male connectors.

In an embodiment, each apex connector is hollow and comprises one or more openings in external facing surfaces thereof.

In an embodiment, the elongate frame members comprise a hollow elongate body with one or more support ribs extending substantially along a longitudinal length of the elongate body.

In one form of the above embodiment, at least one of the support ribs provides a receiving surface for supporting or retaining a rigid sidewall member.

In an embodiment, each apex connector comprises channel forming lips along an outer edge thereof configured to align with channel forming lips of elongate frame members when connected thereto.

In an embodiment of the first or second aspects, the apex connectors are formed from a polymer material and the elongate frame members are formed from a light metal or light metal alloy.

In a fourth aspect of the invention, there is provided a method comprising assembling components of a kit according to the third aspect of the invention and/or embodiments and/or forms thereof to form a box plinth.

In a fifth aspect of the invention, there is provided a use of the box plinth of the first or second aspects of the invention and/or embodiments and/or forms thereof, or assembled from a kit of the third aspect of the invention and/or embodiments and/or forms thereof as a display box, e.g. for displaying items within or thereon.

In a sixth aspect of the invention, there is provided an apex connector for use as a component of the box plinth of the first or second aspects of the invention and/or embodiments and/or forms thereof.

In an embodiment, each apex connector comprises a plurality of male connectors. Preferably each male connector is orthogonal to each other. Preferably, each apex connector comprises three male connectors.

In an embodiment, each apex connector is hollow and comprises one or more openings in external facing surfaces thereof.

In an embodiment, each apex connector comprises channel forming lips along an outer edge thereof configured to align with channel forming lips of an elongate frame members of the box plinth.

In an embodiment, the apex connectors are formed from a polymer material.

In a seventh aspect of the invention, there is provided an elongate frame member for use as a component of the box plinth of the first or second aspects of the invention and/or embodiments and/or forms thereof.

In an embodiment each elongate frame member comprises two female connectors at opposite longitudinal ends thereof.

In an embodiment, the elongate frame members comprise a hollow elongate body with one or more support ribs extending substantially along a longitudinal length of the elongate body.

In one form of the above embodiment, at least one of the support ribs provides a receiving surface for supporting or retaining the rigid sidewall member.

In an embodiment, the elongate frame members are formed from a light metal or light metal alloy.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an isometric view of a box plinth according to a preferred embodiment of the present invention.

FIG. 2 shows the box plinth illustrated in FIG. 1 with the top skin removed.

FIG. 3 shows the box plinth illustrated in FIG. 2 with the top wall removed.

FIG. 4 is a detailed view of an upper portion of the box plinth illustrated in FIG. 3 with the top wall exploded.

FIG. 5 is a detailed view of an upper portion of the box plinth illustrated in FIG. 3 with the top wall in place.

FIG. 6 is a section view of the box plinth illustrated in FIG. 1 with all but one wall removed and all but one of the skins in place.

FIG. 7 is an isometric view of an extrusion used in the formation of the box plinth illustrated in FIG. 6.

FIG. 8 is an end view of the extrusion illustrated in FIG. 7.

FIG. 9 is an isometric view of a corner block used in the formation of the box plinth illustrated in FIG. 6.

FIG. 10 is an end view of the corner block illustrated in FIG. 9.

FIG. 11 is an isometric view of a box plinth according to another preferred embodiment of the present invention.

FIG. 12 is an exploded view of the box plinth shown in FIG. 11.

FIG. 13 is an isometric view of only the frame without any side walls or sheet members.

FIG. 14 is an exploded view of the frame shown in FIG. 13.

FIG. 15 is an isometric view of an extrusion assembly, including an extrusion and a pair of mounting assemblies.

FIG. 16 is an isometric view of the mounting assembly shown in FIG. 15.

FIG. 17 is an exploded view of the mounting assembly shown in FIG. 16

FIG. 18 is an isometric view of a corner block assembly used in the formation of the box plinth illustrated in FIG. 11.

FIG. 19 is an exploded view of the corner block assembly shown in FIG. 18.

FIG. 20 is an isometric view of box plinth according to another embodiment of the invention.

FIG. 21 is an exploded isometric view of the box plinth of FIG. 20.

FIG. 22 is a perspective view of an elongate frame member and apex connectors used to form the box plinth of FIG. 20.

FIG. 23 is a cross-sectional view of an elongate frame member of FIG. 22, in a direction perpendicular to the longitudinal length thereof.

FIG. 24 illustrates an alternative implementation of a box plinth comprising an open planar face with a plurality of shelves disposed within the box plinth.

### DESCRIPTION OF EMBODIMENTS

The invention broadly relates to a box plinth, such as for use as a display box, and related methods. The box plinth generally includes an open frame structure formed from a number of apex connectors and elongate frame members extending therebetween, to generally form a rigid open frame three-dimensional polygon (e.g. an open frame box). The edges of the elongate frame members include a channel forming lip, such that when the apex connectors and elongate frame members are connected to form the open frame three-dimensional polygon, each plane of the open frame has a channel around an outer perimeter thereof. The channel is sized to hold one or more side and end wall members therein, such as a rigid or semi-rigid side wall members and/or rigid end wall members.

In one implementation the box plinth can be assembled and disassembled as required and, more importantly, by changing the at least one planar sidewall which may be removably located relative to the frame, the external appearance of the box plinth can thus be adjusted as necessary. In addition, partial disassembly may be possible. Due to the provision of the rigid frame, side wall members can be removed from the frame to reduce weight and the frame moved with side wall members repositioned after relocation of the frame to complete reassembly of the box plinth.

The provision of removable side wall members means that the external appearance of the box plinth can be adjusted as required simply by removing and replacing the side wall members. For example, side wall members may be removed and replaced with different side wall members having different visual appearance. In the alternative, the sidewall members may be removed and modified to have different visual appearance before being replaced.

In another implementation, the side wall members are configured to receive a display skin to provide the box plinth with a particular visual appearance. In this implementation, the visual appearance of the box plinth may be adjusted by removing the skins from the side wall members and then applying a new skin of different visual appearance. In such implementations, it is preferred that the skins are magnetically attachable to the side wall members, for example, the side wall members may be formed from a magnetic receptive material (e.g. ferro paper) and the skins is magnetic (or the opposite arrangement), such that the skins are magnetically adhered to the side walls, and can be peeled off and replaced as required.

Changes to the external appearance of the box plinth can take any form including changing colour, changing finish and even potentially changing external shape of the box plinth to a degree provided that the one or more sheet members can be engaged with the channel forming lip of the box plinth at the edges. In other words, the semi-rigid sheet members or skins may be substantially planar but may be shaped to change the external shape of the box plinth.

The rigid frame will preferably be a three-dimensional shape which will typically define the shape and overall dimensions of the box plinth. The rigid frame can be manufactured from a pair of end frame assemblies and a number of elongate frame members extending between the end frame assemblies. The end frame assemblies each include a number of elongate frame members and typically all of the frame members including the elongate frame members extending between the frame assemblies will preferably have the same configuration and external shape.

The components of the rigid frame will typically be releasably attachable relative to one another. Any mechanism of attachment may be used. Preferably the apex connectors and elongate frame members are connected to one another via a friction fit coupling. However, a snap fit attachment could be used. Other mechanisms or combination of mechanisms may also be used, for example a snap fit mechanism may be used with one or more threaded fasteners to “lock” the snap fit assembly may be used in order to increase the security of attachment.

Alternatively, a spring pin may be used in combination with correspondingly shaped attachment block and/or attachment bracket. In embodiments, where attachment brackets are used, the attachment bracket may include a pair of spaced apart arms and a wall connecting the spaced apart arms. Each of the spaced apart arms may extend from an end of the connecting wall. Each arm may extend perpendicular, or substantial perpendicular, to the connecting wall. The pair of spaced apart arms may also extend parallel, or substantially parallel, to one another. Each arm may extend in the same direction. Each arm may further include an aperture for receiving a portion of a spring pin. The connecting wall may include an aperture for receiving an anchor portion for receiving at least a portion of a screw. The anchor portion may include an internal thread which corresponds to the thread of a screw. The attachment bracket may be substantially U-shaped.

The components of the rigid frame may be manufactured from any material. In a preferred embodiment, the elongate frame members will typically be a light metal such as aluminium for example and the apex connectors will typically be plastic although all of the components may be metal or all of the components may be plastic or other suitable materials.

The rigid frame includes a pair of end frame assemblies each formed from a number of alternating apex connectors and elongate frame members extending therebetween. Typically, each of the end frame assemblies has the same shape and configuration. The end frame assemblies may have any shape but typically, the end frame assemblies will be generally rectangular including four apex connectors, one at each corner and four elongate members extending between the apex connectors. The elongate members and apex connectors are typically joined to form a substantially planar end frame and the planar end frames are typically spaced apart, but connected using a number of elongate frame members extending between respective apex connectors of respective end frame assemblies.

Each of the apex connectors will typically include a number of elongate member attachment portions. In a particularly preferred embodiment where the box plinth is rectangular in shape and therefore the end frame assemblies are each rectangular in shape, each of the apex connectors will include three elongate member attachment portions which are mutually orthogonal. In another particularly preferred embodiment where the box plinth is also rectangular in shape and therefore the end frame assemblies are each rectangular in shape, each of the apex connectors will include two elongate member attachment portions which are mutually orthogonal.

The box plinth may have shapes other than rectangular and in general, the apex connectors will also include three elongate member attachment portions but the attachment portions may not be mutually orthogonal. For example, a hexagonal shape end frame assembly would have two attachment portions at approximately 120° of angle between them with a third attachment portion which is orthogonal to the first two attachment portions. An octagonal shape end frame assembly would have two attachment portions at approximately 135° angle between them with a third attachment portion which is orthogonal to the first two attachment portions. Generally speaking, the orthogonal, third attachment portion of each of the apex connectors is used to attach an elongate frame member to space the respective end frame assemblies apart.

The box plinth of the present invention will preferably have a shape that has a flat or substantially planar upper surface and a flat or substantially planar lower surface, the upper surface to support items or objects thereon and the lower surface to be placed on the floor or other surface. However, other shapes may be provided within the scope of the invention which may not have a planar upper surface and/or a planar lower surface.

In a preferred form, each of the apex connectors will preferably be configured as an attachment block. The apex connectors may be solid but preferably, will be hollow. In preferred forms, each apex connector may include at least one open, or substantially open, side. Each apex connector may include an opening into a hollow interior provided on the opposite side of the apex connector to the open, or substantially open, end. The opening may allow access into the hollow interior of the apex connector. The opening may be sized to receive a tool, such as an Allen or hex key, screw driver or the like.

In a preferred form, each of the apex connectors will have two elongate frame member attachment portions. In the preferred form where the box plinth is provided in the rectangular configuration and includes two elongate frame member attachment portions, the two attachment portions will be provided on adjacent sides with an opening into a hollow interior provided on the opposite sides of the apex connector to form a cuboid apex connector which is hollow. In another preferred form, each of the apex connectors will have three elongate frame member attachment portions. In the other preferred form where the box plinth is provided in the rectangular configuration and includes three elongate frame member attachment portions, the three attachment portions will be provided on adjacent sides with an opening into a hollow interior provided on the opposite sides of the apex connector to form a cuboid apex connector which is hollow. The provision of openings on the opposite sides to the attachment portions and/or open end will typically allow access into the hollow interior of the apex connector and/or the rear of the attachment portions. Each opening may be sized to receive a tool, such as an Allen or hex key, screw driver or the like.

Each attachment portion may include a bore for receiving at least a portion of a screw. Each bore may be a threaded bore. The location of each bore may align, or substantially align, with a corresponding opening provided on the corresponding opposite side of the apex connector.

The attachment portions may have any configuration, but preferably will be a male portion, shaped and sized to be received at least partially within a hollow portion/opening of the elongate frame member. In a preferred form, the attachment portions will be substantially rectangular in shape and extend from the block body of the apex connector. Preferably, the attachment portions will be sized to be closely received, preferably in a friction fit or interference fit within an internal portion of the elongate frame member. One or more outer edges of the attachment portions may be tapered in order to ease insertion of the attachment portions into the elongate frame member.

As mentioned above, it is preferred that the apex connectors are manufactured from plastic and a rigid plastic allowing very limited deformation is particularly preferred.

Each of the apex connectors will also preferably include a channel forming lip on at least one side edge in order to align with the channel forming lip provided on the respective elongate members to continue the channel. The provision of the channel forming lip on each of the apex connectors will typically form an enclosed lip about a perimeter of each of the sides of the box plinth (preferably except the base wall or lower wall) in order to receive and preferably surround a semi-rigid sheet member on each of the sides of the box plinth (preferably except the base wall or lower wall).

The channel forming lip provided on each of the apex connectors will preferably define a corner portion for the lip on each of the sides of the box plinth. In a preferred form, each side of the apex connector opposite to the attachment portions will be provided with a channel forming lip on to side edges or corner edges.

When the box plinth is provided in the rectangular configuration, a channel forming lip is preferably provided on three corner edges of each apex connector in order to define six channels on each apex connector (preferably only two corner edges of each apex connector adjacent to the base wall or lower wall).

In a particularly preferred embodiment, the channel forming lip on the apex connector will preferably be provided as a part of an extension portion which extends from a corner of the apex connector with a pair of wall portions which each define a channel (therefore two channels are provided relative to the corner) with the wall portions or lips provided at approximately 90° to one another (in the rectangular embodiment) such that each defines a channel parallel with the side surface of the apex connector.

It is preferred that the channel forming lips and the channels themselves are provided outside the side surface of the apex connector and frame members and the frame assembly generally.

In a preferred embodiment, the extension portion has a substantially triangular shape with two sidewalls each with a lip extending from an apex of the triangular shape to define the channels.

The extension ribs or portions will therefore typically be dimensioned to correspond with the thickness of the rigid side wall members such that when the sidewalls are located in the opening, an outer surface of each of the rigid sidewalls is coplanar with the end wall of the extension ribs or portions to define a three-dimensional shape with planar sides with only the channel forming configuration to receive the semi-rigid sheet member located outside the three-dimensional shape.

Each of the extension ribs or portions will preferably extend from two opposed side walls of the elongate frame member and be configured as a pair of spaced apart, substantially parallel sidewalls with a linking wall at an outer end thereof. As mentioned above, typically four extension ribs or portions will be provided on each of the elongate frame members, two from each of a pair of opposed sides of the elongate frame member. Preferably, the extension ribs or portions will extend over the length of the elongate frame member.

The spaced apart extension ribs may also provide a grove of recess within which a portion of a preferred spring pin can be received to attach the frame member to an apex connector.

Each elongate frame member may include a reinforced corner box at an outer corner of the frame member where the channel forming assembly is provided. Typically, the reinforced corner box is formed from a pair of walls, substantially at 90° which extend from the linking wall of one of the extension ribs or portions to a sidewall of the frame member.

As mentioned above, the channel forming lip or assembly preferably extends from the corner of the preferred corner box of each of the elongate frame members. Each channel forming assembly of a preferred embodiment will typically have an arrow shape or configuration with a pair of substantially planar wall portions each with a lip which is spaced from but parallel to respective sidewalls of the elongate frame member to define a channel between an inner surface of the lip and an outer surface of the frame member. When connected with the preferred apex connector with a similar channel forming configuration, a channel is typically defined about a perimeter of the box plinth on each side (preferably except the base side).

Preferably, the dimension of the channel forming assembly will be optimised to minimise the visible profile or size of the channel forming assembly and maximise the dimension of the semi-rigid sheet members are provided that the channel forming configuration be sufficiently large to ensure a good seat in the channel for the edge of the semi-rigid sheet member.

The box plinth of the present invention also includes a number of rigid side wall members removably located relative to the rigid frame to at least partially close the open frame shape. Each of the rigid sidewalls will typically be dimensioned to be received in an opening in a side or end of the open frame to close the open frame. Each of the rigid sidewalls will typically be substantially planar. One or more openings may be provided there through in order to allow a user to insert their fingers to grip the rigid side wall for assembly and removal. Each of the rigid side wall members may be manufactured from any material but a simple, strong but relatively light material such as award or plastic will be preferred. A particularly preferred material is medium density fibreboard or MDF board.

Preferably each of the rigid side wall members will be between 5 mm and 20 mm thick with a thickness of 12 mm being particularly preferred.

An outer surface of each of the rigid side wall members will typically be smooth.

In an implementation, the box plinth includes at least one, and typically a number of planar side walls in the form of a semi-rigid sheet member which are removably located relative to the frame at each edge by location of an edge of the semi-rigid sheet member in the respective channel with the flexible sheet member(s) located substantially parallel to an outside the respective rigid side wall member.

The semi-rigid sheet members according to the present invention may be coloured and/or textured and/or include other information such as advertising or branding information in order to suit the desired visual appearance of the box plinth. The semi-rigid sheet member may include an adhesive surface for mounting a magnetic sheet.

The semi-rigid sheet members will preferably be sufficiently flexible to allow some deformation to insert the semi-rigid sheet members into the channel and to remove the semi-rigid sheet members from the channel when required. The flexibility may be due to the thickness of the semi-rigid sheet member, for example a rigid sheet member may be provided which is sufficiently thin enough and large enough in dimension to be sufficiently deformable to allow insertion and removal but rigid enough to be self-supporting. It is important that the semi-rigid sheet members be self-supporting so as not to collapse when installed on the box plinth, particularly on the sides and/or the ends of the box plinth. However, it will be appreciated in other embodiments, the planar side wall may be formed from a rigid material which is not easily removed from the rigid frame. In such cases, the appearance of the box plinth may be adjusted by applying a skin to the surface of the planar side wall (e.g. through the use of magnetic and magnet receptive materials).

Normally, planar side wall or a semi-rigid sheet member will be provided on each of all of the sides of the box plinth except the base wall.

The planar side wall or semi-rigid sheet member(s) may be manufactured from any material, but typically this will be formed from a self-supporting plastic or polymer sheet.

Each planar side wall or semi-rigid sheet member will typically be provided with an edge portion, preferably about a perimeter of the planar side wall or semi-rigid sheet member with a thickness to be received in the channel. Preferably, the thickness of the planar side wall or semi-rigid sheet member will substantially correspond with the dimension of the channel in order to be closely received, preferably in a friction or interference fit within the channel.

The semi-rigid sheet member will typically be manually deformed in order to insert the edge of the semi-rigid sheet member into the channel and to remove the semi-rigid sheet member from the channel.

The box plinth of the present invention may also include at least one, and typically a number of magnetic sheet members. In preferred embodiments, each magnetic sheet is mountable to a corresponding planar side wall or semi-rigid sheet member. Together, each planar side wall or semi-rigid sheet member and at least one magnetic sheet may form a planar side wall or semi-rigid sheet member sheet assembly.

The box plinth of the present invention may also include at least one, and typically a number of skin members for mounting to a corresponding semi-rigid sheet member sheet assembly. Each skin member may be magnetic such that each skin member is magnetically mountable to the corresponding semi-rigid sheet member sheet assembly. Advantageously, the skin members may be changed in order to obtain different visual effects.

Importantly, as mentioned above, once the box plinth is assembled, any change that is required or desired to the external appearance of the box plinth can be simply and relatively inexpensively achieved by simply removing the semi-rigid sheet members or skin members on the outside of the box plinth and replacing them with alternative semi-rigid sheet members or skin members without requiring that the entire box plinth be replaced as is required with conventional box plinths.

The invention will be described below in relation to one or more embodiments thereof.

In one embodiment there is provided a box plinth 10 and a related method of assembly. The box plinth 10 of the embodiment illustrated in the accompanying Figures comprises a rigid frame formed from a pair of end frame assemblies each formed from a number of alternating apex connectors 11 and elongate frame members 12 extending therebetween; a number of elongate frame members 13 extending between respective apex connectors 11 of the respective end frame assemblies to form a three-dimensional open frame shape. Each of the elongate frame members 12, 13 includes a channel-forming lip 14 to define a channel 15 on an outermost side of each of the frame members 12, 13. A number of rigid sidewall members 16 are removably located relative to the rigid frame to at least partially close the open frame shape. A semi-rigid sheet member 17 is removably locatable relative to the frame at each edge by location in the respective channel 15 locating the semi-rigid sheet member 17 substantially parallel to and outside the respective rigid sidewall member 16.

In use, the box plinth 10 of the preferred embodiment can be assembled and disassembled as required and, more importantly, by changing the semi-rigid sheet members 17 which are removably located relative to the frame on the exterior of the box plinth 10, the external appearance of the box plinth 10 can be adjusted as necessary.

In addition, partial disassembly may be possible. Due to the provision of the rigid frame, the rigid side wall members 17 can be removed from the frame to reduce weight without the rigid frame collapsing and the rigid frame moved whilst still assembled and then the rigid side wall members 16 repositioned with the sheet members 17 then relocated to complete reassembly of the box plinth 17.

The provision of the semi-rigid sheet members or skins 17 means that the external appearance of the box plinth 10 can be adjusted as required simply by changing the skins 17 as required. The external appearance of the box plinth 10 can take any form including changing colour, changing finish and even potentially changing external shape of the box plinth 10 to a degree provided that the semi-rigid members 17 can be engaged with the channel forming lip 14 of the box plinth 10 at the edges of the semi-rigid sheet members or skins 17. In other words, the semi-rigid sheet members or skins 17 may be substantially planar but may be shaped to change the external shape of the box plinth 10.

The rigid frame of the illustrated embodiment is a three-dimensional rectangular shape which also defines the shape and overall dimensions of the box plinth 10. As mentioned above, the rigid frame is manufactured from a pair of end frame assemblies and a number of elongate frame members 13 extending between the end frame assemblies. The end frame assemblies each include a number of elongate frame members 12 and in the illustrated, preferred embodiment, all of the frame members 12, 13 including the elongate frame members 13 extending between the end frame assemblies have the same configuration and external shape as shown.

The components of the rigid frame are releasably attachable relative to one another and any mechanism of attachment may be used. Preferably, a snap fit attachment is used although another mechanism or combination of mechanisms may be used, for example a snap fit mechanism may be used with one or more threaded fasteners to “lock” the snap fit assembly may be used in order to increase the security of attachment.

The components of the rigid frame may be manufactured from any material. In a preferred embodiment, the elongate frame members 12, 13 are a light metal such as aluminium for example and the apex connectors 11 are plastic.

As illustrated, each of the end frame assemblies has the same shape and configuration. The end frame assemblies of the illustrated embodiment are generally rectangular including four apex connectors 11, one at each corner and four elongate members 12 extending between the apex connectors 11. The elongate members 12 and apex connectors 11 are joined to form a substantially planar end frame and the planar end frames are typically spaced apart, but connected using a number of elongate frame members 13 extending between respective apex connectors 11 of respective end frame assemblies.

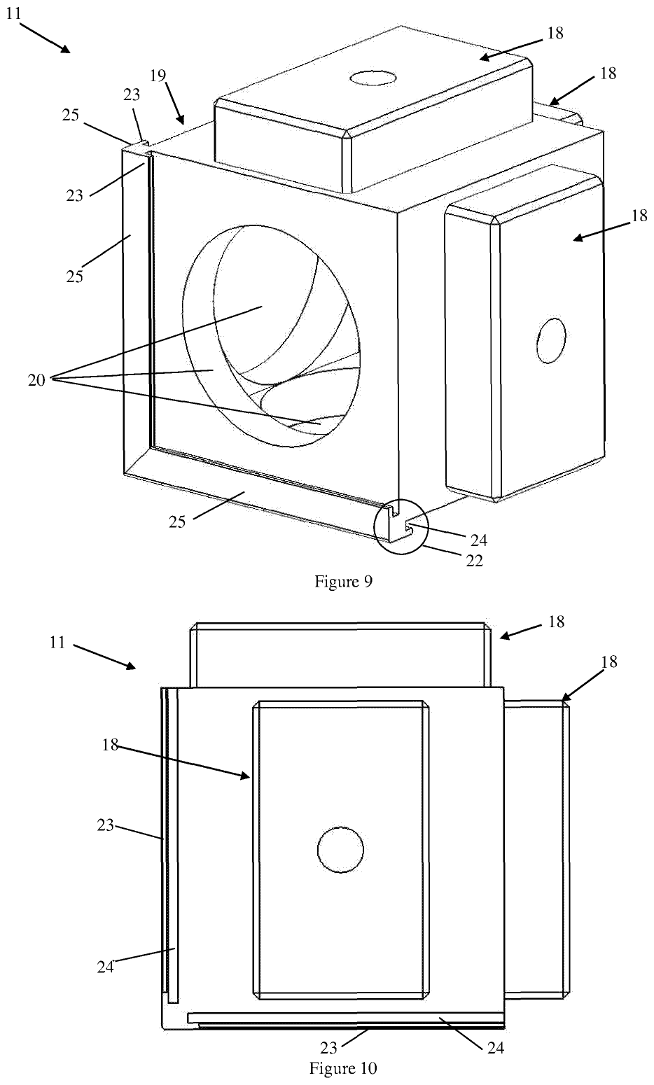

As illustrated in FIGS. 9 and 10 in particular, each of the apex connectors 11 includes a number of elongate member attachment blocks 18. In the illustrated preferred embodiment where the box plinth 10 is rectangular in shape, the end frame assemblies are each rectangular in shape, and each of the apex connectors 11 include three elongate member attachment blocks 18 which are mutually orthogonal.

In the illustrated preferred form, each of the apex connectors 11 is configured as an attachment block which has a hollow body 19 with three elongate frame member attachment blocks 18. The three attachment blocks 18 are provided on adjacent sides with an opening 20 into a hollow interior of the body 19 provided on each of the three opposite sides of the apex connector 11 to the attachment blocks 18, to form a cuboid apex connector 11. The provision of openings 20 on the opposite sides to the attachment blocks 18 allows access into the hollow interior of the apex connector body 19 and/or the rear of the attachment blocks 18 as shown in FIG. 9.

The attachment blocks 18 illustrated are shaped and sized to be received at least partially within a hollow portion/opening 21 of the elongate frame member 12, 13. In a preferred form, the attachment blocks 18 are substantially rectangular in shape and extend from the body 19 of the apex connector 11. The attachment blocks are sized to be closely received, preferably in a friction fit or interference fit within an opening or bore 21 of an elongate frame member 12, 13. As shown in FIGS. 9 and 10, one or more outer edges of the attachment blocks 18 are tapered in order to ease insertion of the attachment blocks 18 into the elongate frame member 12, 13.

As mentioned above, it is preferred that the apex connectors 11 are manufactured from plastic and a rigid plastic allowing very limited deformation is particularly preferred.

Each of the apex connectors 11 also includes a channel forming configuration 22 with a pair of channel forming lips 23 on a pair of corner side edges in order to align with the channel forming lip 14 provided on the respective frame members 12, 13 to continue the channel 15. The provision of the channel forming lips 23 on each of the apex connectors 11 preferably forms an enclosed lip about a perimeter of each of the sides of the box plinth 10 (preferably except the base wall or lower wall) in order to receive and surround a semi-rigid sheet member 17 on each of the sides of the box plinth 10 (preferably except the base wall or lower wall).

The channel forming configuration 22 provided on each of the apex connectors 11 preferably define a corner portion of the channel 14 on each of the sides of the box plinth 10. In a preferred form, a corner edge on each side of the apex connector 11 opposite to the attachment blocks 18 is provided with a channel forming configuration 22 on two side edges or corner edges.

When the box plinth 10 is provided in the rectangular configuration, a channel forming configuration 22 is preferably provided on three corner edges of each apex connector 11 in order to define six channels 14 on each apex connector 11 (preferably only two corner edges of each apex connector adjacent to the base wall or lower wall).

In a particularly preferred embodiment, the channel forming lips 23 on the apex connector 11 are provided as a part of a configuration 22 which extends from a corner of the apex connector 11 with a pair of wall portions 25 each with a lip 23 which each define a channel 24 (therefore two channels 24 are provided relative to the corner) with the wall portions 25 with lips 23 provided at approximately 90° to one another (in the rectangular embodiment) such that each defines a channel 24 parallel with the side surface of the apex connector 11.

It is preferred that the channel forming lips 23 and the channels 24 themselves are provided outside the side surface of the apex connector 11 and frame members 12, 13 and the frame assembly generally.

In a preferred embodiment, the extension configuration 22 has a substantially triangular shape with two walls 25 each having a lip 23 extending from an apex of the triangular shape to define the channels 24.

Each of the end frame assemblies include a number of elongate frame members 12 and the rigid frame also includes a number of frame members 13 extending between respective apex connectors 11 of the respective end frame assemblies. Preferably all of the elongate frame members 12, 13 in the frame of the preferred embodiment will have the same configuration.

It is preferred that the elongate frame members 12, 13 are formed by an extrusion process and therefore, have the same shape and configuration over the length of the frame member 12, 13.

Each frame member 12, 13 is provided with an internal opening or bore 21 extending through the elongate member 12, 13. As illustrated best in FIGS. 8 and 9, each of the elongate frame members 12, 13 are generally rectangular having four extension ribs 26 extending from two of the four sides of the generally rectangular frame member 12, 13. The extension ribs 26 preferably strengthen the elongate frame member 12, 13 and also provide a surface to support the rigid side wall members 16 relative to the rigid frame. When the frame is assembled, the extension ribs 26 of adjacent frame members 12, 13 which are in the same plane preferably define an opening into which a rigid side wall member 16 can be removably located in order to close the open, rigid frame and form a closed box.

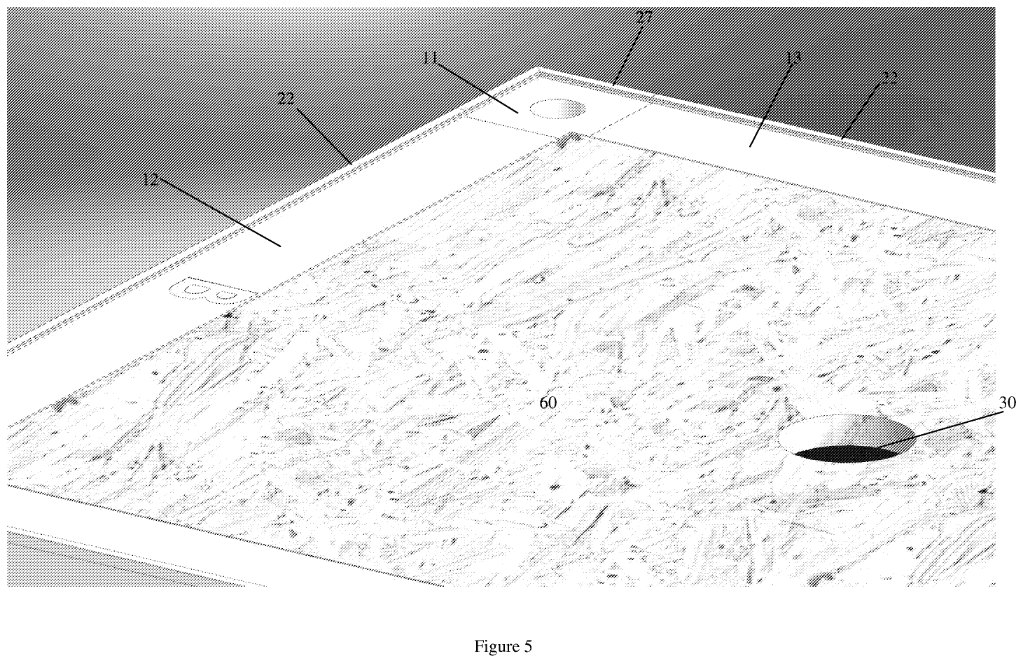

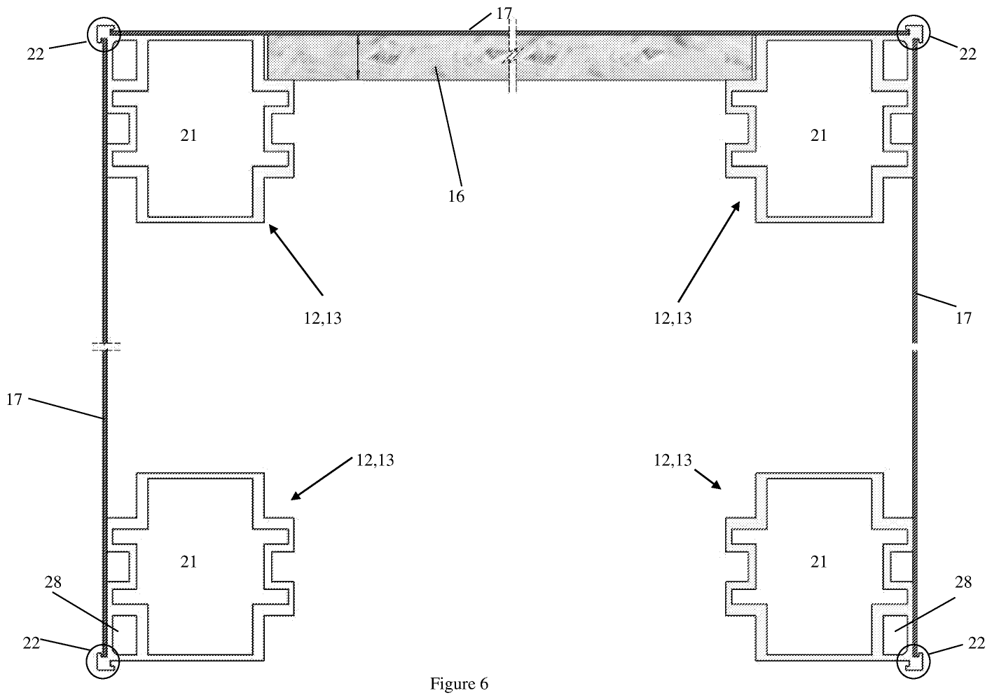

The extension ribs 26 are located on the frame members 12, 13 to correspond with the thickness of the rigid side wall members 16 such that when the sidewall members 16 are located in the opening, an outer surface of each of the rigid sidewall members 16 is coplanar with the end wall of the extension ribs 26 as shown in FIGS. 5 and 6 to define a three-dimensional shape with planar sides with only the channel forming configuration 27 to receive the semi-rigid sheet member 17 located outside the three-dimensional box shape.

As illustrated, each of the extension ribs 26 extend from two opposed side walls of the elongate frame member 12, 13 and are each configured as a pair of spaced apart, substantially parallel sidewalls with a linking wall at an outer end thereof. As mentioned above, four extension ribs 26 will be provided on each of the elongate frame members 12, 13 illustrated, two from each of a pair of opposed sides of the elongate frame member 12, 13. Preferably, the extension ribs 26 extend over the length of the elongate frame member 12, 13.

Each elongate frame member 12, 13 illustrated include a reinforced corner box 28 at an outer corner of the frame member 12, 13 where the channel forming configuration 27 is provided. As shown, the reinforced corner box 28 is formed from a pair of walls, substantially at 90° which extend from the linking wall of one of the extension ribs 26 to a sidewall of the frame member 12, 13.

As mentioned above, the channel forming configuration 27 extends from the outer corner of the corner box 28 of each of the elongate frame members 12, 13. Each channel forming configuration 27 of the illustrated embodiment has an arrow shape with a pair of substantially planar wall portions 29 each with a lip 14 which is spaced from but parallel to respective sidewalls of the elongate frame member 12, 13 to define a channel 15 between an inner surface of the lip 14 and an outer surface of the frame member 12, 13. When connected with the apex connector 11 with a similar channel forming configuration 22, a channel 15, 24 is defined about a perimeter of the box plinth 10 on each side (preferably except the base side).

Preferably, the dimension of the channel forming configuration 22, 27 is minimised/optimised to minimise the visible profile or size of the channel forming configuration 22, 27 and maximise the dimension of the semi-rigid sheet members 17 provided that the channel forming configuration 22, 27 is sufficiently large to ensure a good seat in the channel 15, 24 for the edge of the semi-rigid sheet member 17.

Each of the rigid sidewalls 16 is dimensioned to be received in an opening in a side or end of the open frame, to close the open frame. Each of the rigid sidewalls 16 is substantially planar. One or more openings 30 may be provided therethrough in order to allow a user to insert their fingers to grip the rigid side wall 16 for assembly and removal. Each of the rigid side wall members 16 may be manufactured from any material but a simple, strong but relatively light material such as award or plastic will be preferred. A particularly preferred material is medium density fibreboard or MDF board.

Preferably each of the rigid side wall members will be between 5 mm and 20 mm thick with a thickness of 12 mm being particularly preferred, but this depends on the application with the thickness of the rigid side wall members used also adjusting the position of the extension ribs 26 on the frame members 12, 13 to ensure a flush finish.

An outer surface of each of the rigid side wall members 16 will typically be smooth.

The semi-rigid sheet members 17 are removably located relative to the frame, outside the rigid side wall members 16 at each edge by location of the respective edge of the semi-rigid sheet member 17 in the respective channel 15, 24 with the flexible sheet member(s) 17 located substantially parallel to, and outside the respective rigid side wall member 16.

The semi-rigid sheet members 17 will be coloured (even if white) and/or textured and/or include other information such as advertising or branding information in order to suit the desired visual appearance of the box plinth 10.

The semi-rigid sheet members 17 are sufficiently flexible to allow some deformation to insert the semi-rigid sheet members 17 into the channel 15, 24 and to remove the semi-rigid sheet members 17 from the channel 15, 24 when required. The flexibility may be due to the thickness of the semi-rigid sheet member 17, for example a rigid sheet member 17 may be provided which is sufficiently thin enough and large enough in dimension to be sufficiently deformable to allow insertion and removal but rigid enough to be self-supporting. It is important that the semi-rigid sheet members 17 be self-supporting so as not to collapse when installed on the box plinth 10, particularly on the sides and/or the ends of the box plinth 19.

As shown in the illustrated embodiment, a semi-rigid sheet member 17 will normally be provided on each of all of the sides of the box plinth 10, except the base wall.

The semi-rigid sheet member(s) 17 may be manufactured from any material but a plastic sheet is preferred as these can be manufactured to be self-supporting.

Each semi-rigid sheet member 17 will typically be provided with an edge portion, preferably about a perimeter of the semi-rigid sheet member 17 with an appropriate thickness to be received in the channel 15, 24. Preferably, the thickness of the semi-rigid sheet member 17 will substantially correspond with the dimension of the channel 15, 24 in order to be closely received, preferably in a friction or interference fit within the channel 15, 24.

The semi-rigid sheet member 17 will typically be manually deformed by an operator in order to insert the edge of the semi-rigid sheet member 17 into the channel 15, 24 and to remove the semi-rigid sheet member 17 from the channel 15, 24.

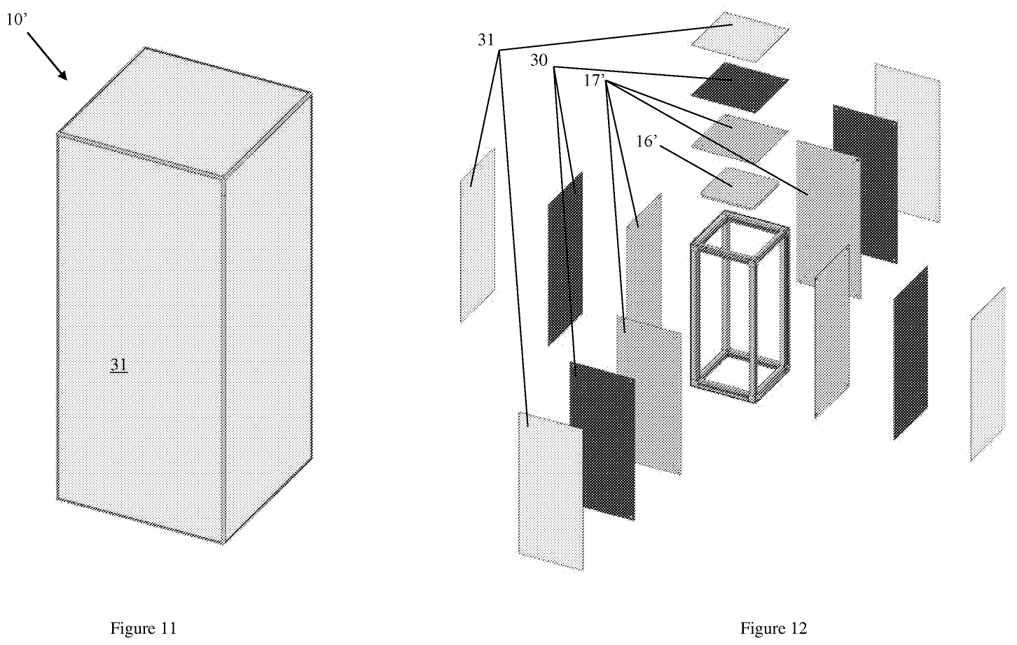

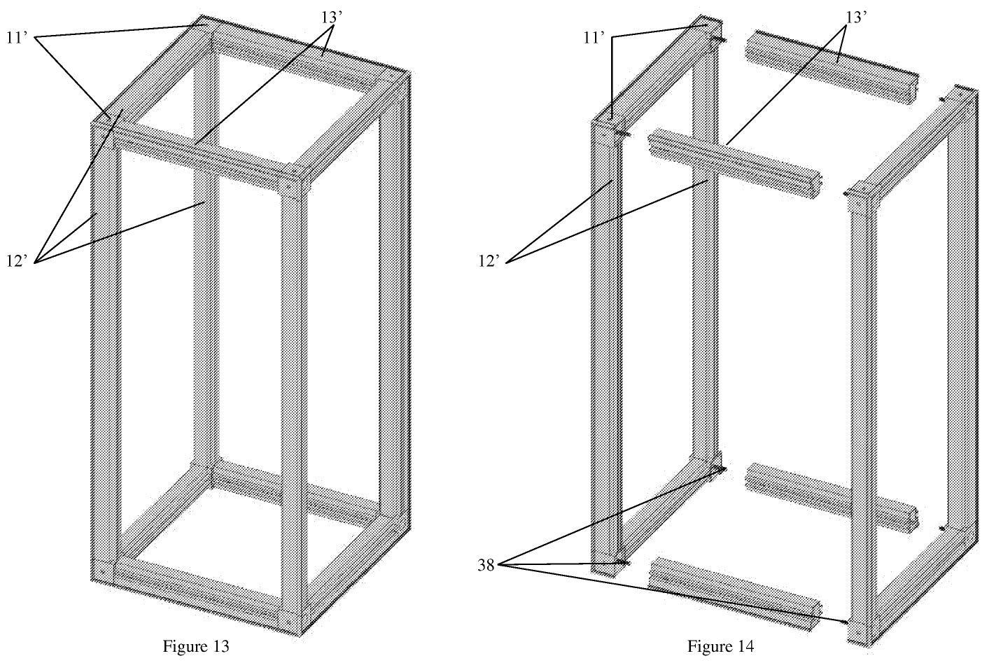

FIGS. 11 to 18 show another preferred embodiment of the present invention, in the form of a box plinth 10′. Similar to the first embodiment, box plinth 10′ includes a ridge frame formed from a pair of end frame assemblies each formed from a number of alternating apex connectors 11′ and elongate frame members 12′ extending therebetween; a number of elongate frame members 13′ extending between respective apex connectors 11′ of the respective end frame assemblies to form a three-dimensional open frame shape. Each of the elongate frame members 12′, 13′ includes a channel-forming lip 14′ to define a channel 15′ on an outermost side of each of the frame members 12′, 13′. A rigid sidewall member 16′ is removably located relative to the rigid frame to at least partially close the open frame shape. A semi-rigid sheet member 17′ is removably locatable relative to the frame at each edge by location in the respective channel 15′ locating the semi-rigid sheet member 17′ substantially parallel to and outside the respective rigid sidewall member 16′.

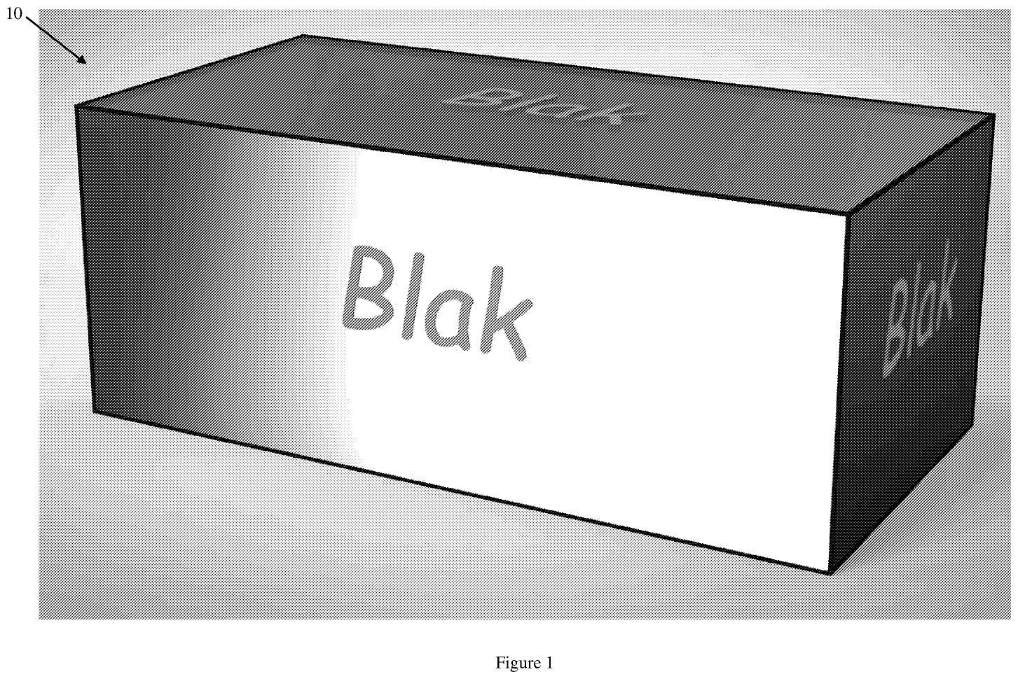

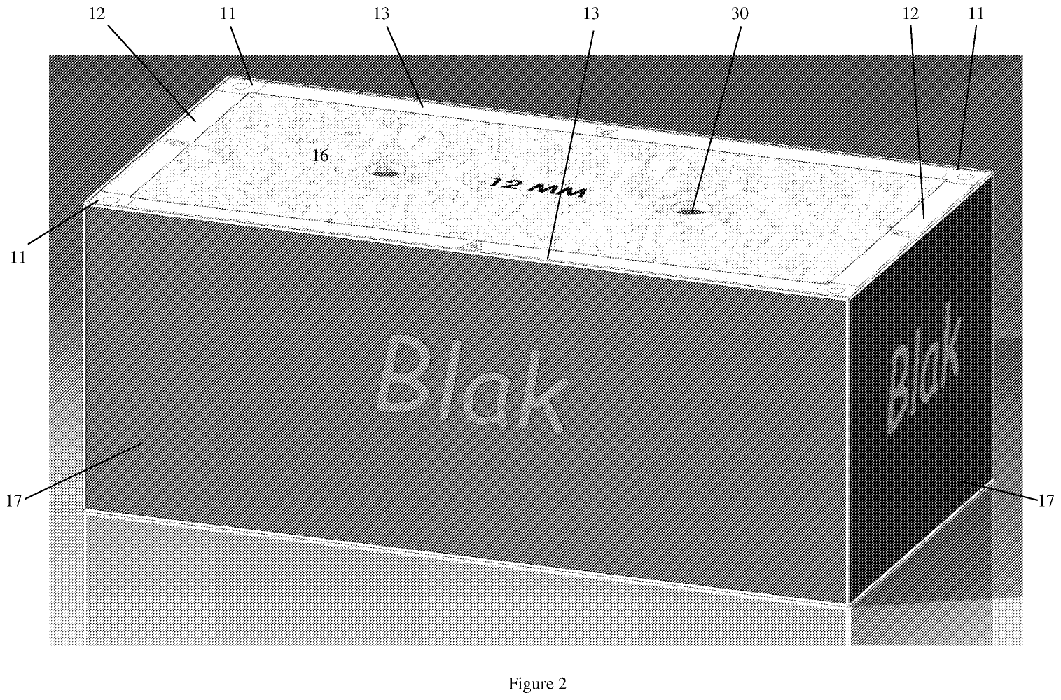

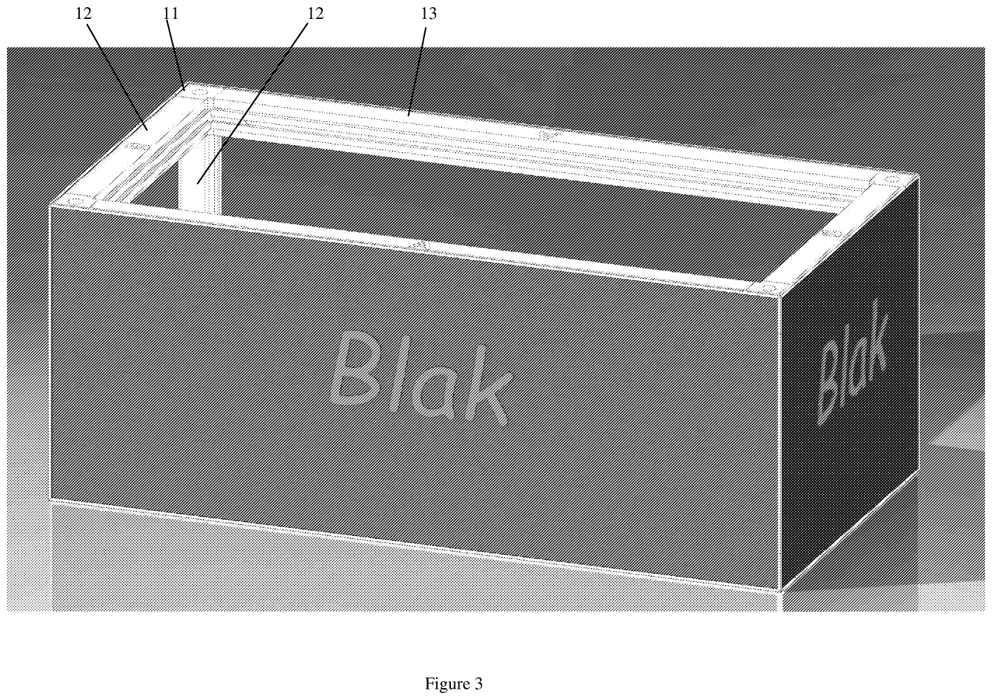

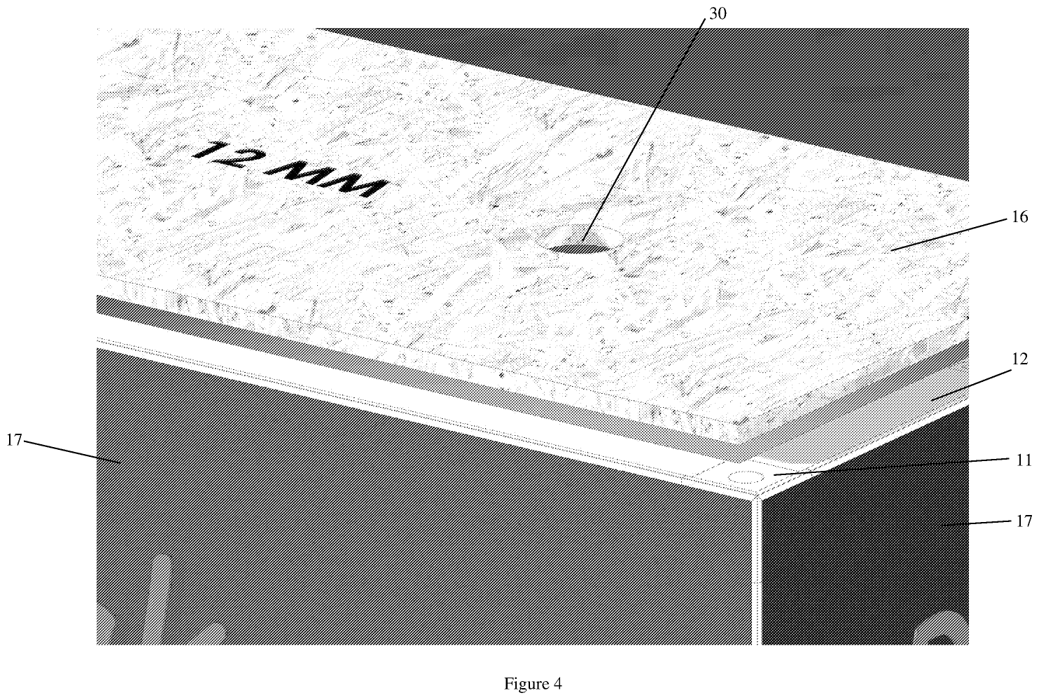

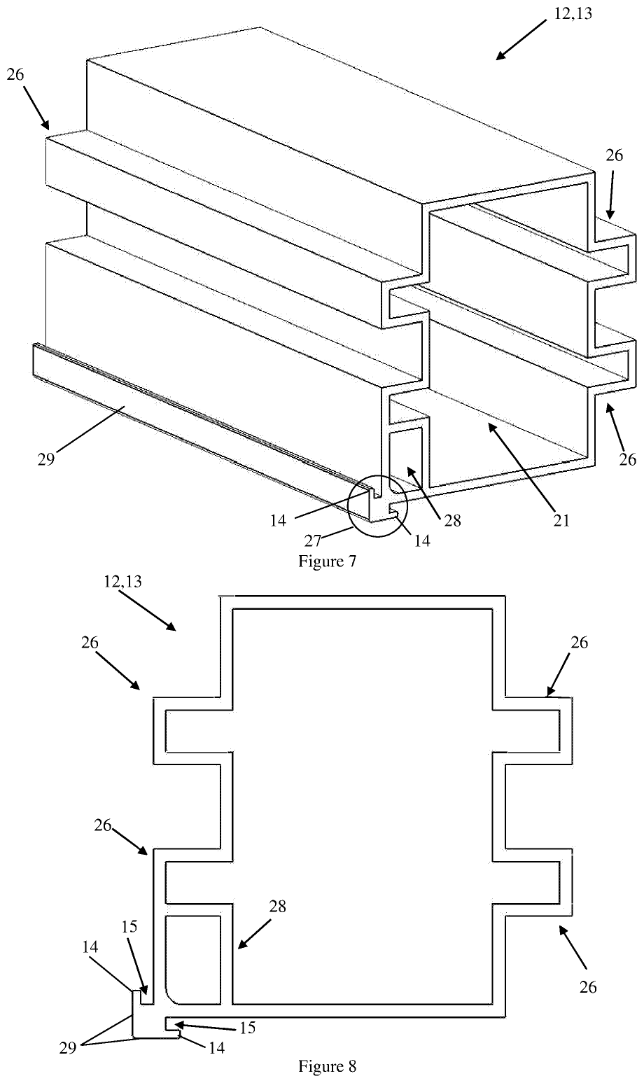

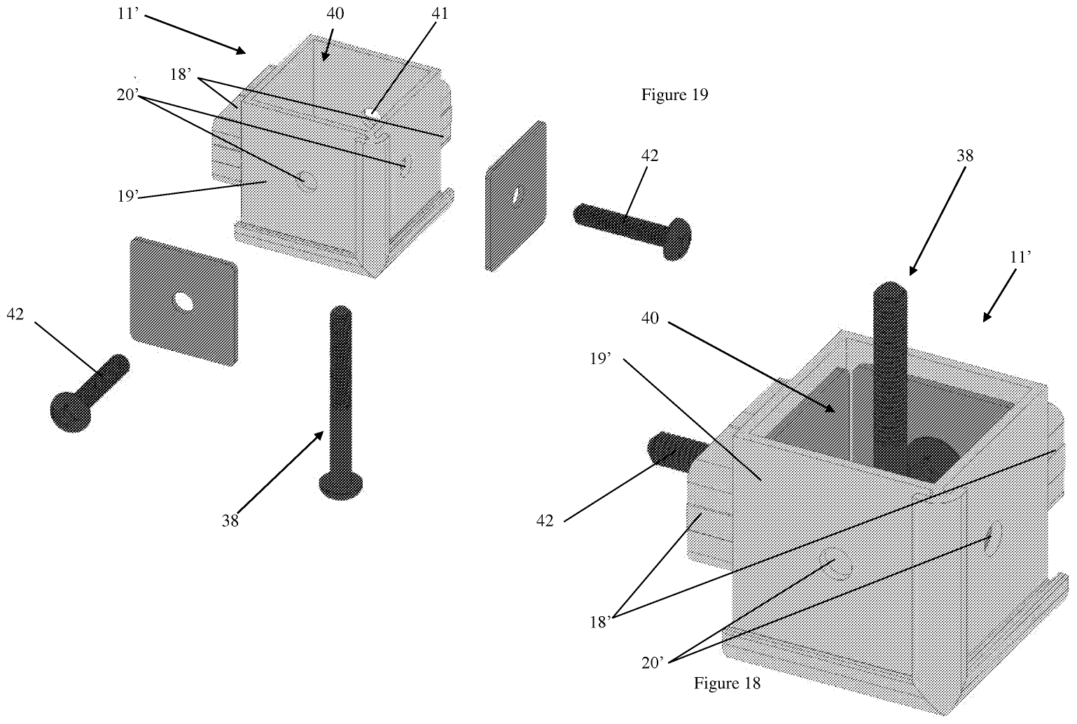

The embodiment shown in FIGS. 11 to 18 differs from the embodiment shown in FIGS. 1 to 23 in that box plinth 10′ further includes a magnetic sheet 30 mountable to each of the semi-rigid sheet members 17′ to form a sheet member assembly and skins 31 mountable to each sheet member assembly. In this preferred embodiment, each semi-rigid sheet members 17′ will have an adhesive outer layer for mounting magnetic sheet 30 thereto.

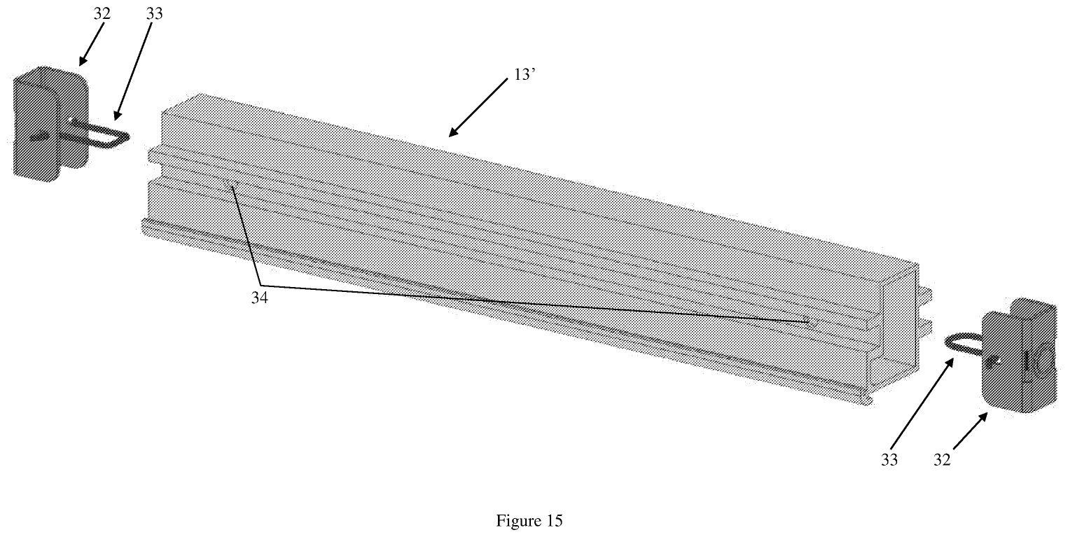

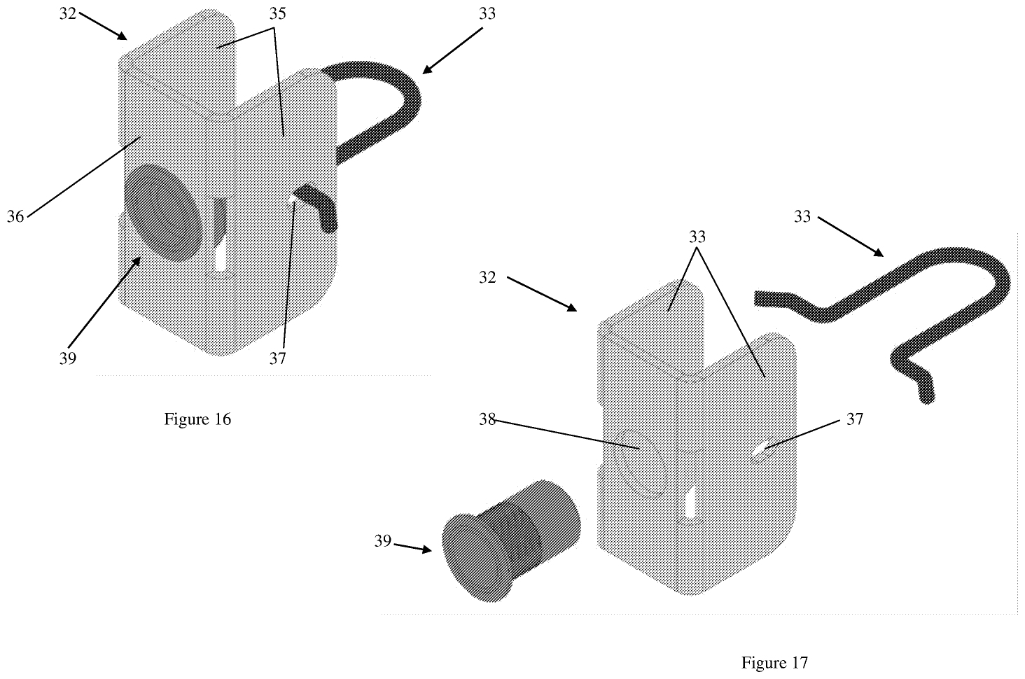

The embodiment shown in FIGS. 11 to 18 further includes attachment brackets 32 and spring pin 33. Each spring pin 33 is mountable to a respective attachment bracket 32 at either end of each elongate frame member 13′ in order to facilitate securing each elongate frame member 13′ to the pair of end frame assemblies. As best can be seen in FIG. 15, elongate frame members 13′ define apertures 34 for receiving a portion of spring pin 33.

As best shown in FIGS. 16 and 17, each attachment bracket 32 includes a pair of arms 35 spaced apart by wall 36 to form a substantially U-shaped bracket. Each arm defines an aperture 37 for receiving a portion corresponding spring pin 33. Wall 36 also defines an aperture 38 for receiving an anchor portion 39 for receiving screw 40. Each anchor portion 39 includes an internal thread which corresponds to the thread of corresponding screw 38 (best shown in FIG. 14).

As best shown in FIGS. 17 and 18, the preferred embodiment shown in FIGS. 11 to 18 includes apex connectors 11′. Apex connector 11′ are substantially similar those shown in the first embodiment described above, with some minor differences described below.

Similar to each apex connector 18 described in relation to the first preferred embodiment, each apex connector 18′ is configured as an attachment block that has a hollow body 19′. Each apex connector 11′, however, includes two elongate member attachment blocks 18′ which are mutually orthogonal (instead of three).

The two attachment blocks 18′ are provided on adjacent sides with an opening 20′ into a hollow interior of the body 19′ provided on each of the two opposite sides of apex connector 11′. Each attachment block 18′ further includes an opening 41 which is coaxial with a corresponding opening 20′. Each apex connector 18′ further includes an open side 40, the open side being located adjacent the two attachment blocks 18′, another opening 20′ into the hollow interior of the body 19′ is provided on the opposite side of the apex connector to open side 40 to form a cuboid apex connector 11′. Similarly, to the first preferred embodiment described above, the provision of openings 20′ allows access into the hollow interior of the apex connector body 19′ and/or the rear of the attachment blocks 18′.

During assembly, screws 42 are located within the hollow interior of body 19′. Screws 42 and 42 are each received within respective openings 41 which are coaxial with openings 20′. A tool is then insertable into each of openings 20′ in order to tighten each of screws 42.

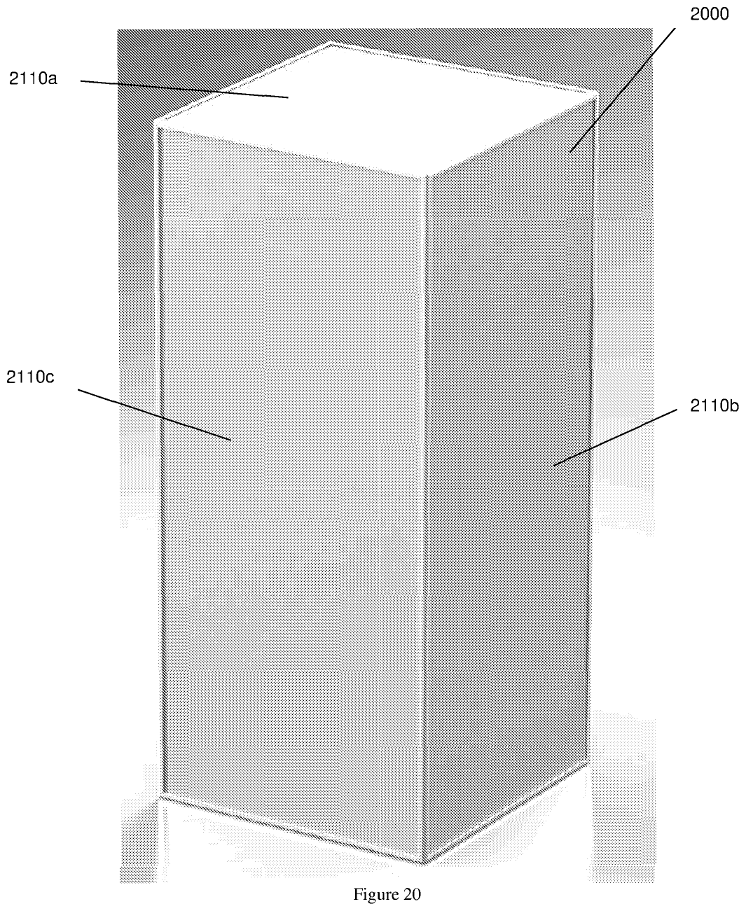

FIGS. 20 to 23 illustrate a further embodiment of the invention.

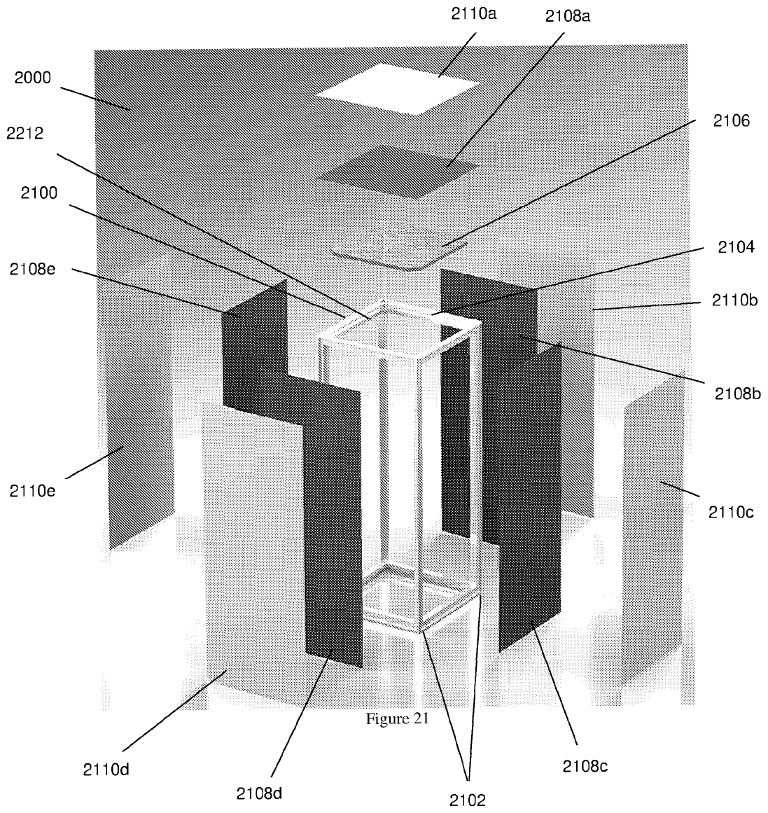

FIG. 20 is an isometric view of box plinth 2000, and FIG. 21 is an exploded isometric view of box plinth 2000. Box plinth 2000 comprises a rigid frame structure 2100 in the form of an open three-dimensional rectangular prism. The rigid frame structure 2100 is formed from a plurality of apex connectors 2102 located at each corner of the rigid frame structure 2100 which are interconnected with a plurality of elongate frame members 2104 which extend between respective apex connectors 2102. Also shown are rigid wall member 2106, five semi-rigid wall members 2108a-2108e, and five magnetic skins 2110a-2110e. The arrangement of these components will be described in more detail below.

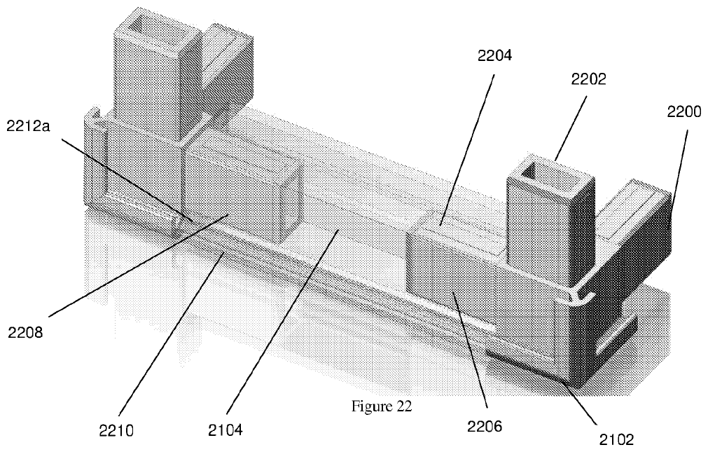

Elongate frame members 2104 and apex connectors 2102 are shown in greater detail in FIG. 22. FIG. 22 is a perspective view of one elongate frame member 2104 connected with, and extending between two apex connectors 2102. Apex connectors 2102 include three male connectors 2200, 2202, and 2204 projecting orthogonally from one another for connecting with a corresponding female connector 2206,2208 in elongate frame members 2104. It is preferred that apex connectors 2102 are formed from plastic and that elongate frame members 2104 are formed from a light metal. In this way, the interaction between plastic male connectors and the metal female connectors provides a tight friction fit. The overall box plinth 2000 framework is built up by interconnecting eight apex connectors 2102 and twelve elongate frame members 2104 as best illustrated in FIG. 21.

Elongate frame members 2104 are generally in the form of rectangular struts which each include a channel forming lip 2210 which protrudes from an outer edge of elongate frame members 2104. Channel forming lip 2210 forms two channels 2212a,2212b on adjacent faces of elongate frame members 2104. Only first channel 2212a is illustrated. Apex connectors 2104 also comprise channel forming lips 2214 on adjacent faces which align and correspond with channel forming lips 2200 on elongate frame members 2104.

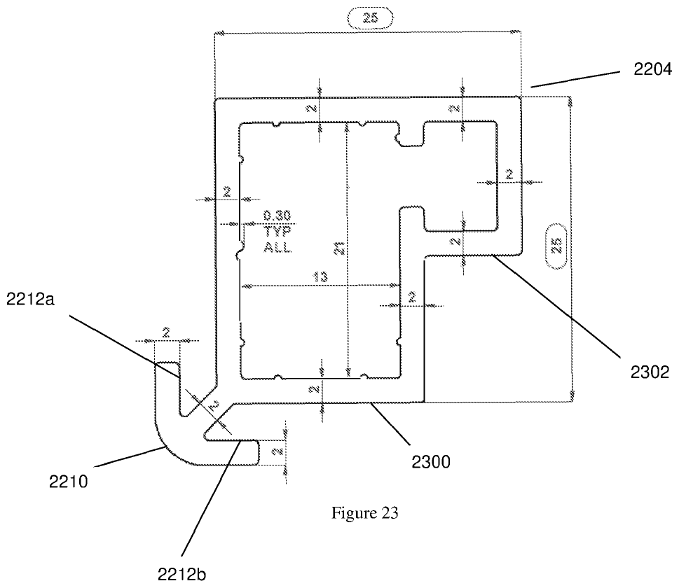

FIG. 23 is a cross-sectional view of elongate frame members 2104 perpendicular to the longitudinal length thereof. Whilst dimensions are provided in FIG. 23, these dimensions relate to one implementation thereof and should not be construed as limiting the disclosure to those dimensions.

From FIG. 23, it can be seen that elongate frame members 2204 comprises a generally rectangular body 2300 in cross-section, channel forming lip 2210 defining channels 2212a,2212b, and support rib 2302 extending along the longitudinal length of elongate frame member 2104. When part of assembled rigid frame structure 2100 of box plinth 2000, channel forming lips 2210 are located on an outermost edge of rigid frame structure 2102, and support rib 2302 are located internally within rigid frame structure 2102. Support rib 2102 has a support surface 2304 to support rigid wall member 2106 if present as part of the overall construction of box plinth 2000.

Returning to FIG. 21, FIG. 21 shows placement of rigid wall member 2106 on top of support surface 2304 to form a ceiling element of the box plinth 2000. The ceiling element may be used to support items placed on top of box plinth 2000.

FIG. 21 also shows the channel forming lips 2210 of adjacent elongate frame members 2104 cooperate to form a perimeter channel 2112 about a planar face bounded by adjacent elongate frame members 2104 and apex connectors 2102. This perimeter channel 2112 is for the purpose of retaining semi-rigid wall members 2108a-2108e on the rigid frame structure 2100. Specifically, edge portions of the rigid wall members 2108a-2108e are retained within the channels which form perimeter channel 2112. To insert or remove semi-rigid wall members 2108a-2108e from perimeter channel 2112, the semi-rigid wall members 2108a-2108e are partially flexed so that they elastically buckle and can be fitted into or displaced from perimeter channel 2112.

In the present embodiment, semi-rigid wall members 2108a-2108e have a laminate structure (not illustrated) that comprises a semi-rigid polymer base material (such as PU, PP, PE, or PPE) and a paper or polymer film layer adhered thereto, the paper or polymer film layer being magnetic or comprising the magnet receptive material. A suitable paper layer being Ferro Paper, which is an adhesive paper with iron filings embedded therein. The purpose of this is to provide a surface against which a display layer, in the form of magnetic skins 2110a-2110e can be easily magnetically attached and removed. In this way, the appearance of the box plinth can easily be changed, e.g. in this embodiment magnetic skins 2110a-2110e can be easily removed, interchanged, and/or modified as required to provide skins with difference appearance, colour, patterning, texture etc. as desired.

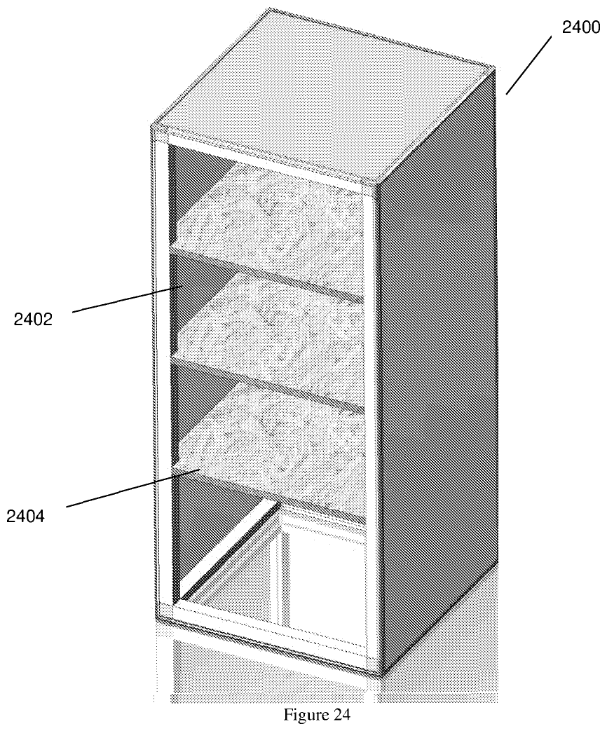

FIG. 24 illustrates an alternative implementation of a box plinth 2400 having the same general construction as described above, but comprising an open planar face 2402 with a plurality of shelves 2404 disposed within box plinth 2400.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A box plinth comprising:
a rigid frame structure in the form of an open frame three-dimensional polygon, the rigid frame structure comprising:
a plurality of apex connectors, and
a plurality of elongate frame members connected to and extending between respective apex connectors of the plurality of apex connectors to form the rigid frame structure;
wherein each elongate frame member comprises a channel forming lip along an outer edge thereof to form a channel along the length thereof, which together with neighboring elongate frame members forms a perimeter channel about each planar face of the open frame polygon, the perimeter channel configured to receive and retain a planar sidewall therein.

2. The box plinth of claim 1, wherein the box plinth further comprises at least one planar side wall, wherein edges or edge portions of the at least one planar side wall are retained in the perimeter channel to close a planar of the open frame polygon.

3. The box plinth of claim 1, wherein the box plinth further comprises a rigid wall member, removably locatable relative to the rigid frame to at least partially close the open frame shape.

4. A box plinth having
a) a rigid frame including
i. a pair of end frame assemblies each formed from a number of alternating apex connectors and elongate frame members extending therebetween,
ii. a number of elongate frame members extending between respective apex connectors of the respective end frame assemblies to form a three-dimensional open frame shape, each of the elongate frame members including a channel-forming lip to define a channel on an outermost side of each of the frame members,
b) a rigid wall member removably located relative to the rigid frame to at least partially close the open frame shape; and
c) at least one semi-rigid sheet member removably locatable relative to the frame at each edge by location in the respective channel, the at least one semi-rigid sheet member located substantially parallel to and outside the respective rigid sidewall member.

5. The box plinth of claim 2, wherein the planar side wall or semi-rigid sheet member is magnetic and/or comprises a magnet receptive material.

6. The box plinth of claim 5, wherein the planar side wall the semi-rigid sheet comprises a semi rigid base layer and a paper or polymer film layer adhered thereto, the paper or polymer film layer being magnetic or comprising the magnet receptive material.

7. The box plinth of claim 3, wherein the rigid wall member forms a base or a ceiling of the box plinth.

8. The box plinth of claim 7, wherein the box plinth includes a second rigid wall member removably located relative to the rigid frame to at least partially close the open frame shape, wherein the second rigid sidewall member forms the other of the base or the ceiling of the box plinth.

9. The box plinth of claim 1, wherein the box plinth is in the form of a cube or rectangular prism.

10. The box plinth of claim 1, wherein each apex connector comprises a plurality of male connectors, and each elongate frame member comprises two female connectors at opposite longitudinal ends thereof, the male connectors configured to be received within the female connectors.

11. The box plinth of claim 1, wherein each apex connector is hollow and comprises one or more openings in external facing surfaces thereof.

12. The box plinth of claim 1, wherein the elongate frame members comprise a hollow elongate body with one or more support ribs extending substantially along a longitudinal length of the elongate body.

13. The box plinth of claim 12, wherein at least one of the support ribs provides a receiving surface for supporting or retaining the rigid sidewall member.

14. The box plinth of claim 1, wherein each apex connector comprises channel forming lips along an outer edge thereof arranged to align with channel forming lips of elongate frame members connected thereto.

15. The box plinth of claim 1, wherein the apex connectors are formed from a polymer material and the elongate frame members are formed from a light metal or light metal alloy.

16. A kit for a box plinth comprising:
a plurality of apex connectors, and
a plurality of elongate frame members configured to be connected to and extend between respective apex connectors of the plurality of apex connectors to form a rigid frame structure in the form of an open frame three-dimensional polygon,
wherein each elongate frame member comprises a channel forming lip along an outer edge thereof to form a channel along the length thereof, which together with neighboring elongate frame members forms a perimeter channel about each planar face of the open frame polygon, the perimeter channel configured to receive and retain a planar sidewall therein.

17. The kit of claim 16, further comprising at least one planar side wall wherein edges or edge portions of the at least one planar side wall are configured to be retained in the perimeter channel to close a planar face of the open frame polygon.

18. The kit of claim 16, wherein the at least one planar side wall is magnetic and/or comprises a magnet receptive material; and the kit further comprises at least one magnetic skin configured to be magnetically retained on the at least one planar side wall.

19. The kit of claim 16, wherein the kit further comprises a rigid wall member configured to be removably located relative to the rigid frame to at least partially close the open frame structure.

20. A method comprising assembling components of a kit according to claim 16 to form a box plinth.

21. (canceled)

22. (canceled)

23. (canceled)
